(19) United States
(12) Patent Application Publication
(10) Pub. No.: US 2009/0169813 A1
(43) Pub. Date: Jul. 2, 2009

(54) NON-SOLVENT, SILICONE COATING/SEALANT INCORPORATING RECYCLED EPDM

(76) Inventor: Richard A. West, Lakewood, OH (US)

Correspondence Address: Fay Sharpe LLP, 1228 Euclid Avenue, 5th Floor, The Halle Building, Cleveland, OH, 44115, US

(21) Appl. No.: 12/261,890

(22) Filed: Oct. 30, 2008

Related U.S. Application Data
(60) Provisional application No. 60/983,793, filed on Oct. 30, 2007.

(51) Int. Cl. D06N 7/04; C09D 147/00; C09D 183/06; C08K 3/26; C09J 183/06; C09J 147/00

(52) U.S. Cl. 428/141; 525/105; 524/426; 524/506

(57) ABSTRACT

A one-component, moisture-curing silicone rubber roof coating or sealant is manufactured using approximately 5-30% recycled EPDM rubber fill. The coating can be incorporated with a polyurethane foam insulation layer to form a roof assembly. Preferably, the EPDM roofing material is removed from an existing structure. It is processed forming powder on the order 50-200 mesh particle size and incorporated into a solvent-free silicone polymer to form a coating or sealant.

This application claims the benefit of U.S. Provisional Application Ser. No. 60/983,793, filed Oct. 30, 2007, which is incorporated herein by reference.

### BACKGROUND

This application relates to a cost effective and long lasting building envelope solution for weatherproofing commercial and industrial buildings. Particularly, this disclosure is directed to a solution that incorporates recycled EPDM from a prior roofing system to create a non-solvent, silicone coating or sealant that incorporates the recycled EPDM. It will be appreciated, however, that this technology may also find use in related environments and applications.

Known silicone and polyurethane technology is used in the construction industry and provides a versatile, energy efficient insulation product that adds the best possible long-term solution to weatherproofing commercial and industrial buildings. Specifically, polyurethane foam is spray applied over a roof deck or existing roof and provides a seamless blanket of insulation to roofs and walls. The polyurethane foam adheres to almost all common building materials and conforms to any configuration. Over the polyurethane foam is provided a silicone base coat which, in turn, is then provided with a high performance silicone top coat. As is known, silicone is inorganic and a very abundant element. The silicone provides a unique array of physical properties and outstanding weathering performance. The silicone can be applied by a contractor in a simple one-component, moisture cure system, or as a fully cured, vulcanized rubber accessory.

The EPDM single ply roofing system is widely used because of its UV stability, ozone resistance, fire rating, and durability and in fact is one of the most popular types of flat roofs installed in commercial and industrial roofs.

It is estimated that approximately one billion square feet of EPDM roofing is installed per year and, likewise, approximately one billion square feet of EPDM roofing is removed each year. Removed EPDM roofing typically is sent to a landfill. A need exists for a sustainable solution for recycling EPDM that is environmentally beneficial, economically viable, and functionally equivalent to the existing product. EPDM has approximately a 50 year life although such EPDM roofing systems are removed between 10-20 years.

Accordingly, a need exists for reusing EPDM, and likewise developing a silicone coating/sealant that incorporates recycled EPDM in a usable, effective, and efficient manner.

### SUMMARY OF THE INVENTION

A method of forming a silicone coating or sealant comprises forming a powder from removed EPDM roofing material, and mixing the recycled EPDM powder with a solvent-free silicone polymer to form at least one of a coating and sealant.

The EPDM roofing material is removed from an existing structure, and chopped into smaller pieces. The EPDM is then washed to remove contaminants. Metal is likewise removed with a magnet. Thereafter, the EPDM material is cryogenically treated, i.e., frozen, then ground into a powder having a particle size of approximately 50-400 mesh.

A reactive silicone polymer is mixed with a non-reactive silicone plasticizer. Thereafter, a fumed silica is added, and then a slow reacting cross-linking material is also added. Powder is then added to this mixture. The powder includes recycled EPDM and preferably at least one of TiO2, calcium carbonate, quartz, carbon black, or other solid fillers. Thereafter a fast cross linking material and adhesion promoter, as well as a metallic type catalyst, are added to the mix. This results in a one-component, moisture-curing silicone rubber roof coating or sealant comprised of approximately 5-30% recycled EPDM rubber fill.

A roof assembly consists of roof deck with a solvent free silicone/recycled EPDM rubber layer received as a waterproofing membrane over a polyurethane insulation layer. Optionally, the roof assembly includes an abrasion resistant top coat that is received over the recycled EPDM rubber layer. The top coat may be solvent based and often adds ceramic granules for durability. The silicone/EPDM membrane may also be used as a means of restoring or maintaining existing roof systems such as metal, built up, EPDM, or other types of roofs.

A primary benefit is the ability to incorporate recycled EPDM roofing material into a new construction material, particularly into a new coating or sealant.

Another benefit associated with the present disclosure is the ability to apply the silicone coating incorporating the recycled EPDM in the same manner that existing silicone and polyurethane foam technologies are used in the construction industry today, that is, easily rolled or sprayed with an airless sprayer.

Yet another advantage is that using recycled EPDM in a solvent-free silicone coating results in excellent cross linking and the recycled EPDM with its large amount of carbon black provides a good UV inhibitor, viscosity enhancer, and will readily cross-link and add strength to the finished coating. Solvent based silicone coatings are not presently adaptable to use recycled EPDM because of the intolerability of EPDM to the hydrocarbon solvents.

Ultimately, the total silicone roof system provides long term performance, ease of maintenance, and a fully sustainable system that is environmentally friendly, energy conscious, and is fully adaptable for use in roofing systems or as a separate sealant incorporating the recycled EPDM.

Still other benefits and advantages of the present disclosure will become apparent from reading and understanding the following detailed description.

### BRIEF DESCRIPTION OF THE DRAWINGS

FIG. 1 shows a roofing system of the type applicable to the present disclosure.

### DETAILED DESCRIPTION OF THE INVENTION

When an existing EPDM roofing system is removed from a building structure, various parts of the roofing system must be removed before the EPDM is recycled. For example, flashings, seams, adhesives, fasteners, contaminated sheets, and preferably any other non-EPDM material are removed. The EPDM is then chopped into smaller pieces and washed in water, for example, in a free tumbling process. The washed components of old EPDM roofing material are then dried and passed through a magnet or other metal separator. Thereafter, the EPDM material is cryogenically treated, i.e., frozen, and then ground to a powder to reduce the finished particle size to 50 mesh or smaller (approximately 50-400 mesh). This results in a recycled EPDM powder that contains substantial particles of carbon black.

As is known, EPDM is intolerable of hydrocarbon solvents. If mixed with such solvents, the EPDM swells and becomes very difficult to handle. According to the present disclosure, however, the ability to use the recycled EPDM in a silicone coating or sealant is made possible with a solvent-free silicone. Particularly, the silicone coating is believed to cross link with the recycled EPDM open molecular sites. The recycled EPDM in powder form provides a reactive filler and it will replace all TiO2 in the silicone coating or sealant. The inclusion of recycled EPDM to replace the TiO2 in a typical silicone based formulation coating results in a significant cost savings. For example, the specific gravity/density of EPDM is 1.4 and TiO2 is approximately 2.0. Silicone coating is typically sold by the gallon. The recycled EPDM may cost on the order of 50 cents per pound or 25 cents per gallon. TiO2, which is also a typical filler in silicone coatings and sealants, costs on the order of one dollar a pound, which translates to approximately 50 cents per gallon. Yet another common filler is calcium carbonate which costs approximately 5 cents per pound or translates to about 10 cents per gallon. Thus, replacing the more expensive TiO2 with the recycled EPDM results in a significant cost savings. The recycled EPDM can also replaces other solid fillers such as quartz.

Using a conventional filler of TiO2 and calcium carbonate results in a weight of about 30 pounds per square foot for weight on the roof. Incorporating the recycled EPDM reduces the overall weight by about 15%.

The recycled EPDM is added to the silicone in an amount on the order of 5-30%, or more preferably about 20%, of the solvent-free silicone coating or sealant.

By way of example, an old EPDM roof is removed from an existing structure and formed into the powder as described above. A coating or sealant is then manufactured in the following manner. A 40-60% low viscosity silicone polymer is mixed with a 5-20% non-reactive silicone plasticizer preferably having a low viscosity of 50-450 cps in a high speed disperser set at low speed. Thereafter, approximately 1-6% untreated fumed silica is added to the mixture, along with 0.5%-3% carbon black powders, and 1-5% slow acting silicone cross linker. These materials are then mixed at medium speed for approximately 1-5 minutes.

Thereafter, the fill materials are added. Approximately 5-30% of recycled 50-400 mesh EPDM roof material is added along with 0-10% TiO2 powders and 3-20% of other fillers such as calcium carbonate, clay, and nepheline syenite (a medium to coarse grain igneous rock that has high strength and weather resistant properties). This combination of materials is then mixed at high speed for approximately 3-10 minutes.

Thereafter, 0.1%-2% adhesion promoter is added along with 1-6% fast acting cross linker. In addition, 0.1%-0.3% of a catalyst is added and the materials mixed for 5-15 minutes at high speed. Specification sheets for these various components are attached as Exhibit 1, although it will be understood that the particular manufacturer or brand name need not be used, and likewise if different brands are used, may slightly alter the percentage ranges provided.

This mixture is then pumped off into containers and preferably blanketed with an inert gas such as nitrogen and thereafter sealed. Typical containers are drums for use in subsequent roofing applications. When used a sealant, the resultant solvent-free silicone is stored in tubes or cartridges for ease of dispensing.

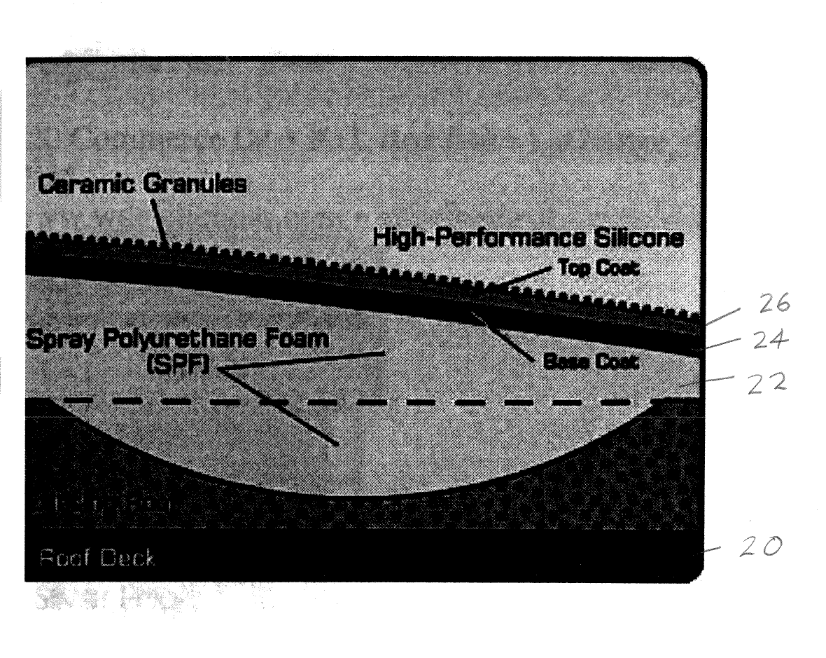

Again by way of example, an existing roof deck 20 (FIG. 1) then includes a solvent-free recycled EPDM rubber layer received over the roof deck, or is used in conjunction with a roof insulating polyurethane foam 22 applied to the roof. As noted previously, the polyurethane foam is typically sprayed into place. The solvent free silicone/EPDM is also used over other existing roof types such as SPF, metal, built up, or single ply as a restoration or maintenance coating.

Provided on the spray polyurethane foam is the solvent-free silicone coating 24 with recycled EPDM manufactured in accordance with the present disclosure. The coating is applied for example on the order of a 30 mil membrane, or other desired thickness as needs require. Optionally, on top of the solvent-free silicone coating incorporating the recycled EPDM is then applied a high performance silicone top coat 26 which usually incorporates a solvent for added strength and is loaded with filler to add desired strength and sufficient amounts of TiO2 to provide additional UV protection.

The silicone sealant incorporating the recycled EPDM can easily be dispensed from caulk tubes. By using the solvent-free base coat, this roofing material eliminates thousands of gallons of solvent being emitted into the atmosphere when compared to a typical roofing project. The new coating/sealant also advantageously allows application of the coating and sealant using existing equipment i.e., sprayers. The coating material is opened at the job site, mixed, and then placed into the pump for application. After approximately 1 hour the applied surface is tack free, and after 4 hours the surface has become a cured film. The coating can be applied at a thickness of approximately 125 mils or ⅛ inch thick in a single pass, as compared with other solvent based coatings that are typically on the order of 15-20 mils thick. The resulting coating has no pin holes etc. and as noted above because the material is solvent-free, more of the material remains on the roofing when compared with a traditional solvent coating. This means that less containers need to be shipped to the roofing project, there is approximately ⅓ less freight charge, ⅓ less labor, and the energy to manufacture the final roofing system is approximately ⅓ less also.

The following commercially available materials were used:

### Catalyst: CATALYST 41 of Wacker Chemie GmbH or Munich, Germany

| Elgenschaften | | | |
|---|---|---|---|
| Properties | | | |
| Dichte bei 20° C. | DIN 51757 | [g/cm³] | 1.09 |
| Density at 20° C. | | | |
| Viskositat bei 23° C. | | [mPa · s] | 4 |
| Viscosity at 23° C. | | | |
| Brechungsindex n_{D}²⁵ | DIN 51423 | | 1.421 |
| Refractive index n_{D}²⁵ | | | |
| Flammpunkt | DIN 51755 | [° C.] | 40 |
| Flash point | | | |
| Zündtemperatur | DIN 51794 | [° C.] | 230 |
| Ignition temperature | | | |

Crosslinker:
CROSSLINKER BO38 of Wacker Chemical Corporation of Adrian, MI
Properties

| | | | |
|---|---|---|---|
| Odor | typical from methyl ethyl | | |
| | ketoxime | | |
| Refractive index n_{D} 25 | | | ca. 1.454 |
| Specific Gravity at 25° C. | DIN 51757 | [g/cm³] | ca. 0.98 |
| Ignition temperature | DIN 51794 | [° C.] | ca. 310 |
| Flash point | DIN 51755 | [° C.] | ca. 60 |

BO30 of Wacker Chemical Corporation of Adrian, MI
Properties

| | | | |
|---|---|---|---|
| Viscosity at 25° C. | DIN 51562 | [mm²/s] | 12 |
| Density at 25° C. | DIN 51757 | [g/cm³] | 0.98 |
| Refractive index n_{D}25 | DIN 51423 | | 1.455 |
| Flash point | DIN 51758 | [° C.] | 84 |
| Ignition temperature | DIN 51794 | [° C.] | 310 |

Fumed Silica:
HDK V15 of Wacker Chemie AG of Munich, Germany

| | Test procedure | Unit | Value |
|---|---|---|---|
| Typical General Properties | | | |
| SiO₂-content¹⁾ | DIN EN ISO 3262- | % | >99.8 |
| | 19 | | |
| loss on ignition²⁾ at 1000° C./2 h | DIN EN ISO 3262- | % | <2 |
| | 19 | | |
| density of SiO₂ | | g/l | 2200 |
| refractive index | | | 1.46 |
| silanol group density | | SiOH/nm² | 2 |
| electric resistivity (density 50 g/l) | | [Ω cm] | >10¹³ |
| Physical-chemical properties | | | |
| BET-surface area | DIN ISO 9277/DIN | m²/g | 130-170 |
| | 66132 | | |
| pH, in 4% aqueous dispersion | DIN EN ISO 787-9 | | 3.8-4.3 |
| tamped density | DIN EN ISO 787-11 | g/l | ca. 50 |
| loss on drying³⁾ (2 h at 105° C.) | DIN EN ISO 787-2 | % | <1.0 |
| sieve residue, acc. to Mocker >40 μm | DIN EN ISO 787-18 | % | <0.03 |

Silicone Polymer:
Elastomer 6N of Wacker Chemie AG of Munich, Germany

| [symbol] | [symbol] |
|---|---|
| Appearance | Colorless liquid/(not miscible with water) |
| Specific Gravity, 25° C. | 0.97 |
| Viscosity, 25° C., cPs | 6,000 |
| Refractive Index, N_{D}²⁵ | 1.404 |
| Flash Point, Pensky-Marten ° C. (° F.) | >148 (>300) |

Adhesion Promoter:
Wacker Silane GF 91 of Wacker Chemical Corporation of Adrian, MI

| Product data | | | |
|---|---|---|---|
| Empirical formula/Molecular weight | | | C8H22N2O3Si/222.4 |
| CAS-number | | | 1760-24-3 |
| Boiling point | 16 mbar/hPa | [° F.] | 297 |
| Refractive index at 25° C. | | | 1.443 |
| Density at 25° C. | | [g/cm3] | 1.02 |
| Viscosity at 25° C. | | [mm2/s] | 4.5 |
| Active content (aminosilanes), near | | [%] | 100 |
| Purity | | [%] | >96 |
| Amine number | | [%] | >8.8 (theory: 9.0) |
| Amine equivalent, approx. | | | 75 |
| Flash point | ISO 2719 | [° F.] | >212 |
| Ignition temperature | DIN 51 794 | [° F.] | 572 |

Carbon Black:
Regal 660R of Cabot Corporation of Billerica, MA
Application Information

Liquid Inks
REGAL 660R pigment black is applicable in liquid inks
requiring low viscosity, high gloss and high jetness. It is
compatible in both aqueous and non-aqueous systems.
Its low structure imparts high gloss when printed on
non-porous substrates.
Coatings
Regal 660R is a low structure, high tinting strength,
regular color pigment black for liquid and powder coating
systems. The lower structure allows for less viscosity
build while maintaining tint strength in both industrial
and architectural markets. It is recommended that an
attritor, sandmill or horizontal mill be used to disperse
this pigment black.
Other Applications
REGAL 660R is suitable for the production of dispersions
for coloring leather articles.
The dispersibility of REGAL 660R pigment black depends
on the equipment used and the formulation. It is relatively
difficult to disperse compared to other blacks used in
packaging applications, but when properly dispersed it
imparts excellent gloss and high jetness.

Fill Materials:
Minex Functional Fillers of the Cary Company of Nephton, Ontario, Canada
PARTICLE SIZE ANALYSIS AND PROPERTIES
Mean Values. These Do Not Represent A Specification.

| | Microns | 2 | 3 | 4 | 7 | 10 |
|---|---|---|---|---|---|---|
| % Finer | 106μ | 100.0 | 100.0 | — | — | — |
| | 75μ | 99.8 | 99.9 | 100.0 | — | — |
| | 45μ | 95.4 | 98.4 | 99.9 | 100.0 | 100.0 |
| | 20μ | 69.2 | 77.7 | 91.6 | 99.3 | 99.3 |
| | 16μ | 57.1 | 67.9 | 85.2 | 98.2 | 99.4 |
| | 10μ | 36.5 | 48.0 | 63.1 | 88.1 | 97.2 |
| | 5μ | 21.3 | 26.0 | 34.5 | 50.5 | 81.0 |
| Hegman Value | ASTM D1210-79 | N/A | N/A | 4.6 | 5.8 | 6.4 |
| Median Particle Size | Sedigraph | 14.3 | 10.8 | 6.8 | 3.5 | 2.1 |
| Specific Surface Area | Fisher Sub Sieve | 0.4 | 0.6 | 0.7 | 1.2 | 1.7 |
| Brightness | Tappi | 85.9 | 86.8 | 88.0 | 89.2 | 89.7 |
| Moisture % | ASTM C-566 | .04 | .05 | .07 | .11 | .15 |
| Oil Absorption | ASTM D-281 | 22.5 | 25.0 | 26.6 | 31.0 | 34.1 |
| pH | AFS 113-87-S | 9.7 | 9.9 | 10.1 | 10.2 | 10.3 |

| | | |
|---|---|---|
| Weight Per Solid Gallon | 21.7 lbs. | ASTM D-153 |
| Bulking Value | 0.0459 | ASTM C-29 |
| Refractive Index | 1.55 | ASTM D-801 |
| Specific Resistance | 3000 ohm-cm | ASTM D-2448 |
| Hardness | 6.0 Mohs | Moh's Scale |

| | Mean Percent by Weight |
|---|---|
| Silicon Dioxide (SiO₂) | 60.20 |
| Aluminum Oxide (Al₂O₃) | 23.60 |
| Sodium Oxide (Na₂O) | 10.50 |
| Potassium Oxide (K₂O) | 4.80 |
| Calcium Oxide (CaO) | .35 |
| Iron Oxide (Fe₂O₃) | .08 |
| Magnesium Oxide (MgO) | .02 |
| Loss on Ignition (L.O.I.) | .42 |

Titanium Dioxide Powder:
DuPont Ti-Pure Titanium Dioxide of E. I. du Pont de Nemours and Company, DuPont
Titanium Technologies, Willmington, DE

| DuPont “Ti-Pure” TiO₂ for Coatings - | | Property | | | | |
|---|---|---|---|---|---|---|
| Dry Grades | | R-900 | R-902+ | R-706 | R-960 | R-931 |
| TiO₂, wt %, min. | | 94 | 93 | 93 | 89 | 80 |
| Alumina, wt % | | 4.3 | 4.3 | 2.4 | 3.3 | 6.4 |
| Silica, wt % | | — | 1.4 | 3.0 | 5.5 | 10.2 |
| Specific Gravity | | 4.0 | 4.0 | 4.0 | 3.9 | 3.6 |
| Bulking Value, | L/kg | 0.250 | 0.250 | 0.250 | 0.255 | 0.275 |
| | gal/lb | 0.030 | 0.030 | 0.030 | 0.031 | 0.033 |

| | | | | | |
|---|---|---|---|---|---|
| Organic Treatment | No | Yes | Yes | No | No |
| Color, CIE L* | 99.8 | 99.6 | 99.4 | 99.9 | 100.0 |
| Median Particle Size, μm | 0.41 | 0.405 | 0.36 | 0.50 | 0.56 |
| Oil Absorption | 15.2 | 16.2 | 13.9 | 18.7 | 35.9 |
| pH | 8.1 | 7.9 | 8.2 | 7.2 | 8.9 |
| Resistance at 30° C. (86° F.), k-ohm | 12 | 8.1 | 10 | 6 | 4 |
| Carbon Black Undertone | 12.4 | 11.7 | 14.5 | 11.6 | 9.8 |
| Standards Classifications | | | | | |
| ASTM D476 | II, III | III, IV, V, VI | II, III, IV, V, VI, VII | III, IV | IV |
| BS 1851/ISO 591/DIN 55912 | R2 | R2 | R2 | R3 | R3 |
| JIS K5116 | R1 | R4 | R2 | R4 | — |

| DuPont “Ti-Pure” TiO₂ for Coatings - | Property | | |
|---|---|---|---|
| Slurry Grades | R-746 | R-942 | R-741 |
| Solids, wt % | 76.5 | 76.5 | 64.5 |
| Grit, Unbrushed, wt %, 325 mesh | 0.010 | 0.010 | 0.015 |
| Grit, Brushed, wt %, 325 mesh | 0.001 | 0.001 | 0.001 |
| Slurry Density, lb/gal | 19.4 | 19.4 | 15.6 |
| Slurry, pH | 8.5 | 9.3 | 8.1 |
| Viscosity, Brookfield at 25 cP | 150 | 250 | 150 |
| Rheology, Hercules Deflection at 500 rpm, cm | 1.2 | 1.7 | 1.5 |
| Emulsion Gloss, 60° at 27 PVC | NA | 43 | NA |
| Emulsion Gloss, 20° at 18 PVC | 59 | NA | NA |
| Biocide, Non-mercuric, Non-formaldehyde Releasing | Yes | Yes | Yes |

¹⁾based on the substance heated at 1000° C. for 2 h
²⁾based on the substance dried at 105° C. for 2 h
³⁾ex works [symbol]
indicates data missing or illegible when filed

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of forming a silicone coating or sealant comprising:
forming a powder from EPDM roofing material; and
mixing the recycled EPDM powder with solvent-free silicone polymer to form one of a coating and sealant.

2. The method of claim 1 further comprising recycling the EPDM roofing material by removing an EPDM roofing material from an existing structure.

3. The method of claim 2 wherein the recycling step includes chopping the removed EPDM roofing into pieces.

4. The method of claim 3 wherein the recycling step includes washing the chopped EPDM pieces.

5. The method of claim 4 includes removing metal from the washed EPDM pieces with a magnet.

6. The method of claim 5 wherein the recycling step includes freezing the removed EPDM roofing material.

7. The method of claim 6 wherein the recycling step includes grinding the frozen roofing material.

8. The method of claim 1 wherein the mixing step includes combining of a silicone polymer with approximately 15% of a non-reactive silicone plasticizer.

9. The method of claim 8 further comprising adding on the order of 35% of a reactive silicone polymer.

10. The method of claim 9 further comprising adding approximately 2% fused silica.

11. The method of claim 10 further comprising adding approximately 2.5% of a slow cross-linking material.

12. The method of claim 11 further comprising adding on the order of 43% powder.

13. The method of claim 12 wherein the powder includes recycled EPDM and at least one of TiO2, calcium carbonate, quartz, and other solid fillers.

14. The method of claim 12 further comprising adding a fast cross-linking material.

15. The method of claim 14 further comprising adding an adhesion promoter.

16. The method of claim 15 further comprising adding a catalyst.

17. A one-component, moisture-curing silicone rubber roof coating or sealant comprising approximately 5%-30% recycled EPDM rubber fill.

18. A roof assembly comprising:
a roof deck; and
spray applied SPF with a solvent-free recycled EPDM rubber layer received over the SPF.

19. The roof assembly of claim 18 further comprising a solvent-based, abrasion resistant top coat received over the recycled EPDM rubber layer.

20. The roof assembly of claim 18 wherein the recycled EPDM rubber layer includes approximately 5-30% recycled EPDM.

21. The roof assembly of claim 20 wherein the recycled EPDM rubber layer includes EPDM particles ranging in size from approximately 50-400 mesh.

22. The roof assembly of claim 18 further comprising a polyurethane foam insulation layer on the roof deck and the solvent-free recycled EPDM rubber layer is received over the insulation layer.

23. A solvent free silicone/EPDM applied directly over an existing roof, such as SPF, single ply, built up, or metal as a restoration or maintenance membrane.
